(19) United States
(12) Patent Application Publication
(10) Pub. No.: US 2013/0241111 A1
(43) Pub. Date: Sep. 19, 2013

(54) Golf Ball Core And Method Of Making A Golf Ball Core

(71) Applicant: NIKE, INC., Beaverton, OR (US)

(72) Inventors: Aaron Bender, Portland, OR (US); Arthur Molinari, Portland, OR (US)

(73) Assignee: NIKE, INC., Beaverton, OR (US)

(21) Appl. No.: 13/779,515

(22) Filed: Feb. 27, 2013

Related U.S. Application Data
(60) Provisional application No. 61/605,070, filed on Feb. 29, 2012.

(51) Int. Cl. A63B 37/00; B29D 99/00

(52) U.S. Cl. CPC A63B 37/0063; B29D 99/0042
USPC 264/327; 473/371; 156/242

(57) ABSTRACT

A method and system for making a golf ball core is disclosed. The method may generally include forming a golf ball core out of a raw core material. The golf ball core may be rapidly heated to begin curing (or vulcanizing) from the outermost surface toward the center of the golf ball core. Before curing the entire golf ball core, the golf ball core may be quenched to stop the curing process. As a result, the golf ball core may include an outer cured zone and an inner uncured zone. In this state, the golf ball core may be incorporated into a finished golf ball to be sold to consumers. Following a set of instructions provided with the golf ball, the consumer may heat the golf ball to customize the properties of the golf ball core, and, thus, the characteristics of the golf ball.

### CROSS-REFERENCE TO RELATED APPLICATION

This application claims priority under 35 U.S.C. §119(e) to U.S. Provisional Patent Application No. 61/605,070, entitled “Golf Ball Core and Method of Making a Golf Ball Core”, and filed on Feb. 29, 2012, which application is hereby incorporated by reference.

### BACKGROUND

The present disclosure relates generally to a method of manufacturing a golf ball having a core with two or more cured core zones. In addition, the present disclosure relates generally to a method of customizing the play characteristics of a golf ball.

The game of golf is an increasingly popular sport at both the amateur and professional levels. A wide range of technologies related to the manufacture and design of golf balls are known in the art. Such technologies have resulted in golf balls with a variety of play characteristics. For example, different golf balls are manufactured and marketed to players having different golfing abilities, such as different swing speeds.

Similarly, a golfer may use different golf balls having different play characteristics depending on the golfer's preferences. For example, different dimple patterns may affect the aerodynamic properties of the golf ball during flight, or a difference in the hardness may affect the rate of backspin. With regard to hardness in particular, a golfer may choose to use a golf ball having a cover layer and/or a core that is harder or softer. A harder golf ball will generally achieve greater distances but less spin, and so will be better for drives but more difficult to control on shorter shots. On the other hand, a softer golf ball will generally experience more spin and therefore be easier to control, but will lack distance.

The manner in which golf balls are made contributes to the play characteristics of the golf ball as well. Balls having a solid construction are generally most popular with the average recreational golfer because they provide a very durable ball while also providing maximum distance. Solid balls may comprise a single solid core encased within a cover material to provide a tough, cut-proof blended cover, often referred to as a “two-piece” golf ball. Such a combination of a single solid core and a cut-proof cover may impart a high initial velocity to such two-piece golf balls that results in improved distance. But the materials used in such two-piece golf balls may be very rigid. As a result, two-piece balls may, depending upon the construction, have a hard “feel” when struck with a club. Likewise, due to their hardness, these two-piece balls may have a relatively low spin rate, which, while providing greater distance, may sometimes be more difficult to control, for example, when hitting an approach shot to the green.

Additionally, the spin rates of golf balls affect the overall control of the balls in accordance to the skill level of the players. Low spin rates provide improved driver and long-iron distance, but make golf balls difficult to stop on shorter shots, such as approach shots to greens. High spin rates allow more skilled players to maximize control of the golf ball, but may adversely affect driver and long-iron distance. To strike a balance between the spin rates and the playing characteristics of golf balls, additional layers, such as intermediate layers, outer core layers and inner cover layers are added to solid golf balls to improve the playing characteristics of the ball. The addition of multiple layers may add to the complexity of the manufacturing process as well as to the expense of manufacturing a golf ball.

While a variety of types of golf balls exist for different play characteristics, amateur golfers generally prefer to minimize the costs of purchasing new golf balls. However, a golfer may be required to purchase several sets of golf balls in order to achieve different play characteristics. For example, a golfer may purchase and use a set of hard golf balls for use specifically on longer courses, when the improved distance achieved by hard golf balls will be advantageous. In addition, a golfer may purchase and use a set of soft golf balls for use on shorter courses, or for use under conditions requiring increased control such as cold or wet weather. The need to purchase, store and carry several sets of golf balls in order to achieve a variety of play characteristics presents an inconvenience to the golfer, as well as increased costs.

In addition, manufacturing golf balls having more than two pieces, i.e., three-piece or four-piece golf balls, can prove time consuming and more expensive than manufacturing a two-piece golf balls. However, a golfer may desire the advantages provided by three-piece and four-piece golf balls, such as higher spin rates to maximize control of the golf ball while maintaining driver distance. Developing a method of manufacturing a two piece golf ball that could provide the benefits of a three-piece or four-piece golf ball could reduce both manufacturing time and the associated expenses of equipment and materials.

Therefore, there is a need in the art for a system and method that addresses the shortcomings of the prior art discussed above.

### SUMMARY

A method and system for making a golf ball core is disclosed. The method may generally include forming a golf ball core out of a raw core material. The golf ball core may be rapidly heated to begin curing (or vulcanizing) from the outermost surface toward the center of the golf ball core. Before initializing cure in the entire golf ball core, the golf ball core may be quenched to stop the curing process. As a result, the golf ball core may include an outer cured zone and an inner uncured zone. In this state, the golf ball core may be incorporated into a finished golf ball to be sold to consumers. Following a set of instructions provided with the golf ball, the consumer may heat the golf ball to customize the properties of the golf ball core, and, thus, the characteristics of the golf ball.

In one aspect, the disclosure provides a method of forming a golf ball core out of a raw core material. The golf ball core may be rapidly heated to begin curing (or vulcanizing) from the outermost surface toward the center of the golf ball core. Before curing the entire golf ball core, the golf ball core may be quenched to stop the curing process. The partially cured golf ball core is then heated again to continue curing the golf ball core. As a result, the golf ball core may include an outer cured zone and an inner cured zone. In this state, the golf ball core may be incorporated into a finished golf ball to be sold to consumers.

In one aspect, the disclosure provides a method of forming a golf ball core out of a raw core material. The golf ball core may be rapidly heated to a temperature of about 350° F. to about 500° F. for about one to about four or six minutes to begin curing (or vulcanizing) from the outermost surface toward the center of the golf ball core. Before curing the entire golf ball core, the golf ball core may be quenched in an ice bath, water bath, cryogenic fluids, dry ice/alcohol bath, or cold/cooled chamber to stop the curing process. The partially cured golf ball core is then rapidly heated again to a temperature of about 280° F. to about 380° F. for about one to about ten minutes to continue curing the golf ball core. As a result, the golf ball core may include an outer cured zone and an inner cured zone. In this state, the golf ball core may be incorporated into a finished golf ball to be sold to consumers.

In one aspect, the disclosure provides a method of forming a golf ball core out of a raw core material. The golf ball core may be rapidly heated to a temperature of about 350° F. to about 500° F. for about one to about four minutes in some embodiments or six minutes in other embodiments to begin curing (or vulcanizing) from the outermost surface toward the center of the golf ball core. The first cure may be any length of time less than the time to cure the entire core, which is typically around eight minutes, depending upon the diameter of the core. Before curing the entire golf ball core, the golf ball core may be quenched in an ice bath, water bath, cryogenic fluids, dry ice/alcohol bath, or cold/cooled chamber to stop the curing process. The partially cured golf ball core is then rapidly heated again to a temperature of about 280° F. to about 380° F. for about one to about ten minutes to continue curing the golf ball core. The three-step cycle of curing, quenching, then curing again is repeated to create another cure zone. As a result, the golf ball core may include an outer cured zone, a middle cured zone, and an inner cured zone. In this state, the golf ball core may be incorporated into a finished golf ball to be sold to consumers.

In one aspect, the disclosure provides a method of forming a golf ball core out of a raw core material. The golf ball core may be rapidly heated to a temperature of about 350° F. to about 500° F. for about one to about four minutes in some embodiments or to about six minutes in other embodiments to begin curing (or vulcanizing) from the outermost surface toward the center of the golf ball core. The initial cure may be any length of time less than would be required to cure the entire core, which is typically around eight minutes, depending upon the diameter of the core. Before curing the entire golf ball core, the golf ball core may be quenched in an ice bath, water bath, cryogenic fluids, dry ice/alcohol bath, or cold/cooled chamber to stop the curing process. The partially cured golf ball core is then rapidly heated again to a temperature of about 280° F. to about 380° F. for about one to about ten minutes to continue curing the golf ball core. Again, before curing the entire golf ball core, the golf ball core may be quenched to stop the curing process. As a result, the golf ball core may include an outer cured zone, a middle cured zone, and an inner uncured zone. In this state, the golf ball core may be incorporated into a finished golf ball to be sold to consumers.

In one aspect, the disclosure provides a method of customizing a golf ball. The method may include heating a golf ball core to cure at least a portion of the golf ball core and rapidly quenching the golf ball core before the golf ball core finishes curing throughout the entire golf ball core such that a portion of the golf ball core is left uncured. The method may also include incorporating the golf ball core into a finished golf ball by applying at least one cover layer. The uncured portion of the golf ball core may remain uncured after the golf ball core is incorporated into the finished golf ball. The method may include heating the finished golf ball. The method may include quenching the finished golf ball. Rapidly quenching the finished golf ball may include quenching the finished golf ball in an ice bath, water bath, cryogenic fluids, dry ice/alcohol bath, or cold/cooled chamber bath. Rapidly quenching the golf ball core may include quenching the golf ball core in an ice bath, water bath, liquid nitrogen, or carbon dioxide/alcohol bath. Heating the golf ball core to cure at least a portion of the golf ball core includes compression molding the golf ball core. Heating the finished golf ball may include heating the finished golf ball in a microwave. Heating the finished golf ball may include heating the finished golf ball in an oven. Heating the golf ball core to cure at least a portion of the golf ball core includes heating the golf ball core to a temperature ranging from about 300° F. to about 500° F.

In one aspect, the disclosure provides a method of customizing a golf ball. The method may include providing a golf ball to a consumer. The golf ball may include a cover layer surrounding a core having at least a cured zone and an uncured zone. The method may include indicating to the consumer to heat the golf ball to a preselected temperature, and then quench the golf ball so as to cause the golf ball to exhibit a desired play characteristic when hit with a golf club. Indicating to the consumer to heat the golf ball may include indicating to the consumer to microwave the golf ball at a preselected power for a preselected length of time. Indicating to the consumer to heat the golf ball may include indicating to the consumer to heat the golf ball in an oven preheated to a preselected temperature for a preselected length of time. Indicating to the consumer to quench the golf ball may include indicating to the consumer to quench the golf ball in a bath of water. Indicating to the consumer to quench the golf ball may include indicating to the consumer to quench the golf ball in a bath of ice and water. The cover layer may include a microwave transparent material.

In one aspect, the disclosure provides a method of customizing a golf ball. The method may include forming a golf ball core by compression molding at least one slug of core material into a golf ball core. The core material may begin to cure during compression molding. The method may include quenching the golf ball core in a fluid to halt the curing of the core material. The method may include covering the golf ball core with a cover layer to form a finished golf ball. The method may include providing the finished golf ball to a consumer. The method may include indicating to a consumer to heat the finished golf ball to a preselected temperature to cause the finished golf ball to exhibit a desired play characteristic when hit with a golf club. The cover layer may include a microwave transparent material. The method may include indicating to the consumer to quench the golf ball to cause the golf ball to exhibit a desired play characteristic when hit with a golf club. Compression molding at least one slug of core material may include heating a mold to about 400° F. In some embodiments, compression molding at least one slug of core material may include heating a mold to 460° F.

In one aspect, the disclosure provides a kit of parts. The kit may include at least one golf ball including a cover layer surrounding a core having a cured zone and an uncured zone. The kit may include a set of instructions indicating to a consumer to heat the golf ball to a preselected temperature, and then quench the golf ball so as to cause the golf ball to exhibit a desired play characteristic when hit with a golf club. The kit of parts may include a stand for holding the golf ball. The uncured zone may include an inner core zone and the cured zone includes an outer core zone surrounding the inner core zone.

In one aspect, the disclosure provides a golf ball. The golf ball may have a core having at least a cured zone and an uncured zone. The golf ball may also have a cover layer surrounding the core. The cured zone may surround the uncured zone. Both the cured zone and the uncured zone may be made of a diene-containing composition.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a flowchart showing details of an embodiment for manufacturing a finished golf ball having a golf ball core with two or more core zones;

FIG. 2 shows three finished golf balls with golf ball cores having cured outer zones that vary in thickness as a function of initial cure time;

FIG. 3 discloses a finished golf ball having a core including three distinct regions;

FIG. 4 is a flowchart showing a method according to an embodiment

FIG. 5 is a flowchart showing details of the method of FIG. 4;

FIG. 6 is a kit that can be used to carry out an embodiment of the disclosed method;

FIG. 7 shows an end-user consumer performing the disclosed method according to multiple embodiments;

FIG. 8 shows a chart that may be included in the kit of FIG. 5;

FIG. 9 is a graph showing the hardness gradient of golf ball cores according to disclosed embodiments compared with a control core made using conventional techniques.

FIG. 10 shows the points on a cross-section of a golf ball core where the hardness was measured.

### DETAILED DESCRIPTION

Generally, the present disclosure provides method for forming a golf ball core having two or more core zones wherein the hardness and/or hardness gradient of an inner core zone may be different or distinct from the hardness and/or hardness gradient of the outer core zone. These core zones are generally achieved by partially curing a material at a first temperature, quenching the golf ball core to stop that curing process, then completing the cure for a desired level at a different temperature. Further, the present disclosure provides methods for customizing a golf ball, in particular, customizing the hardness of a golf ball core, and associated kits that may be used to carry out the methods.

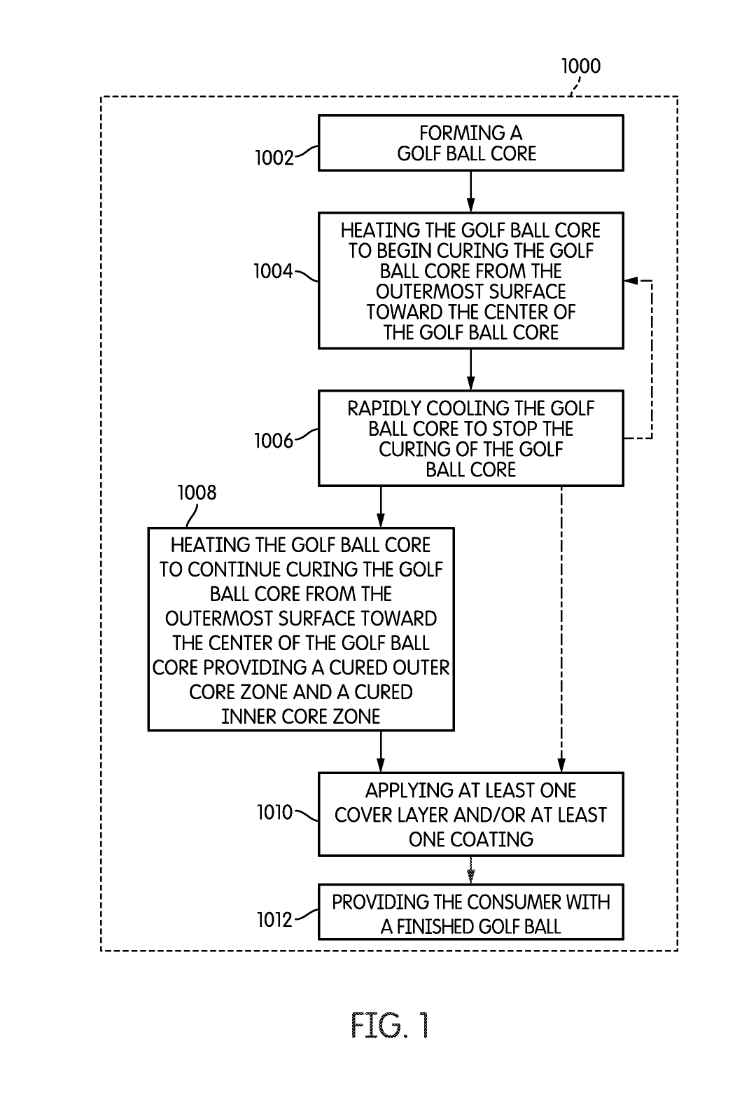

FIG. 1 is a flowchart showing process 1000 of forming a golf ball core. Process 1000 provides a golf ball core that has a hardness gradient unlike standard solid golf ball cores. Standard solid golf ball cores are generally formed and cured once for a sufficient length of time to allow the entire golf ball core or the substantial majority of the golf ball core to cure. For example, a standard solid golf ball core is formed and heated for eight minutes at a temperature of about 329° F. to cure the entire golf ball core material.

In FIG. 1, process 1000 may include manufacturing a finished golf ball having a core with a cured outer core zone and a cured inner core zone. In some embodiments, process 1000 may include manufacturing a finished golf ball having a core with a cured outer core zone and an uncured inner core zone. In further embodiments, process 1000 may include manufacturing a finished golf ball having a core with a cured outer core zone, a cured middle core zone, and an uncured inner core zone. In still further embodiments, process 1000 may include manufacturing a finished golf ball having a core with a cured outer core zone, a cured middle core zone, and a cured inner core zone.

In some embodiments, a finished golf ball is a golf ball that includes all layers and components necessary for the golf ball to be used by a golfer in a game of golf. The finished golf ball may be a two-piece ball, having a core and a cover layer. The finished golf ball may include any number of layers, so long as the golf ball core includes at least a two core zones and at least one cover layer substantially disposed around the core. In addition, the finished golf ball may include a golf ball core with two or more core zones wherein the entire core contains the same rubber material and is formed in one step. In other words, the core is made of one rubber material that has different core zones where each zone may have a different cure level and different hardness properties.

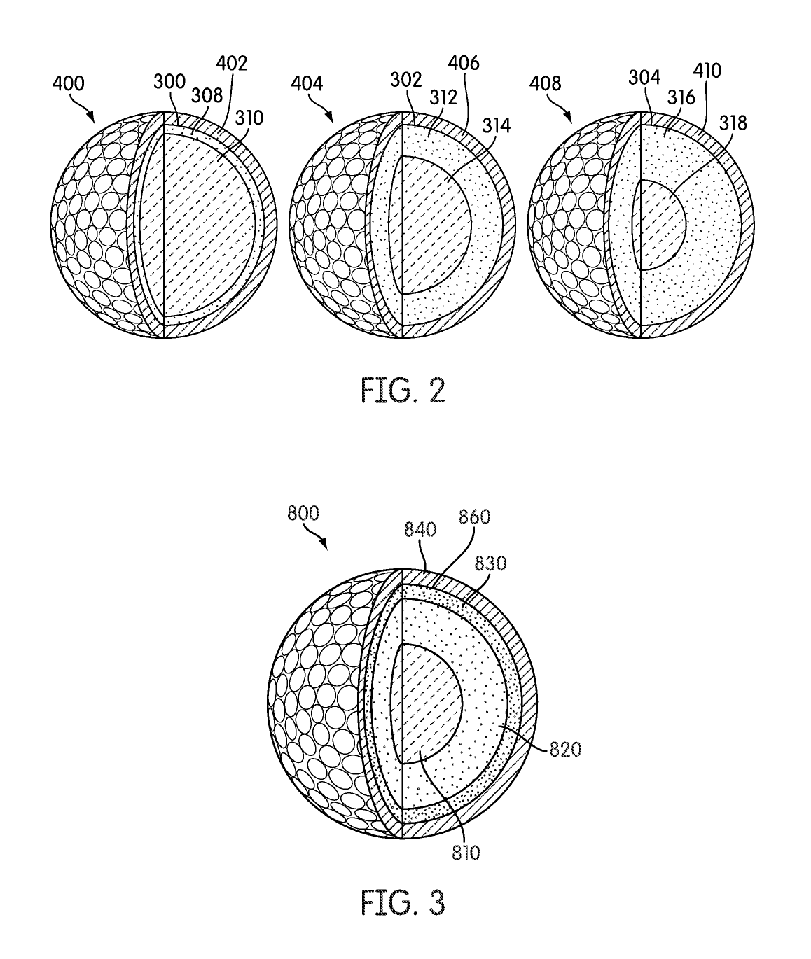

FIG. 2, described in more detail below, shows a finished golf ball 400 with a core having a cured outer core zone and an uncured or differently cured inner core zone. Finished golf ball 400 may include a golf ball core 300 with an outer core zone 308 and an inner core zone 310. Inner core zone 310 may be uncured and outer core zone 308 may be cured. Further, in other embodiments, inner core zone 310 may be cured and outer core zone 308 may be cured, though inner core zone 310 and outer core zone 308 are cured differently to have different hardness properties.

Similar to FIG. 2, FIG. 3 illustrates a finished golf ball 800 having a cover layer 840 and a core 860 including three distinct core zones. An outer core zone 830 may be developed during a first curing process. A middle core zone 820 may be developed during a second curing process. An inner core zone 810 may be developed during a third curing process. Further, inner core zone 810 may be an uncured core zone. Core 860 is formed from one rubber material that has three different core zones, outer core zone 830, middle core zone 820 and inner core zone 810, where each core zone may have a different cure level and different hardness properties.

The material for forming the golf ball core may include a thermoset material. In some embodiments, the thermoset material may be a rubber composition. In general, the material used to form the golf ball core may be material that can be cross-linked or cured to provide a golf ball core with particular hardness properties. In some embodiments, the base rubber of the rubber composition may include polybutadiene, polyisoprene, styrene-butadiene copolymers, metallocene catalyzed polyolefin, natural rubber, and combinations thereof. Typically, a polybutadiene may be used as the base rubber for the golf ball core. More specifically, 1,4-cis-polybutadiene may be used as the base rubber of the golf ball core. Polybutadiene rubbers suitable for use in embodiments of the disclosure include LG BR1208, which is available from LG Chem, LTD, Korea.

However, the skilled practitioner recognizes that polybutadiene rubber is available in various versions, including high-cis (greater than about 92 percent cis structure, typically with less than about 4 percent trans and less than about 4 percent vinyl); low-cis (as little as about 35 percent cis structure) and vinyl, all of which structures is suitable in embodiments of the disclosure.

Typically, high-cis viscosity polybutadiene rubber is used in accordance with the disclosure herein. Polybutadiene having primarily trans structure is not an elastic product, but rather is a crystalline, plastic product. Therefore, polybutadiene comprising primarily trans structure may be mostly excluded from some embodiments where the elastic properties of high-cis are sought, although small amounts of crystalline trans polybutadiene in elastomeric polybutadiene rubber are to be expected, and do not adversely affect the properties and characteristics of the elastic polybutadiene rubber product.

Additives, such as a crosslinking agent and a filler, may be added to the rubber composition. The suitable crosslinking agent can be selected from the group consisting of peroxide, zinc diacrylate, magnesium acrylate, zinc methacrylate, and magnesium methacrylate.

Typically, peroxide may be used as the cross-linking agent in the rubber composition. Organic peroxides suitable as free radical initiators include, for example, dicumyl peroxide (DCP); n-butyl-4,4-di(t-butylperoxy)valerate; 1,1-di(t-butylperoxy)3,3,5-trimethylcyclohexane (TMCH); 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof.

Co-agents can be used with peroxides to improve the cure of the rubber composition. Suitable co-agents include, for example, metal salts of unsaturated carboxylic acids having from 3 to 8 carbon atoms; unsaturated vinyl compounds and polyfunctional monomers (for example, trimethylolpropane trimethacrylate); phenylene bismaleimide; and combinations thereof. Particularly suitable metal salts include, for example, one or more metal salts of acrylates, diacrylates, methacrylates, and dimethacrylates, wherein the metal is selected from magnesium, calcium, zinc, aluminum, lithium, and nickel. In a particular embodiment, the co-agent is selected from zinc salts of acrylates, diacrylates, methacrylates, and dimethacrylates. In another particular embodiment, the co-agent is zinc diacrylate (ZDA).

One or more suitable fillers may be added in the rubber composition, such as zinc oxide, tungsten, barium sulfate, calcium carbonate, and magnesium carbonate. In the disclosed methods, zinc oxide may be used as a filler.

Additional processing aids such as dispersants and activators may optionally be included in the golf ball core material. In particular, zinc stearate may be added as a processing aid (e.g., as an activator).

The materials discussed above may be used to form the golf ball core by the processes described in the disclosure. The golf ball core formed by the process described in the disclosure is formed from a uniform rubber recipe. In other words, the golf ball core is a one-piece core made from a uniform rubber recipe. That same golf core is then heated, quenched, and heated again to provide two or more core zones with the same or different cure levels. The one-piece golf ball core described in the disclosure exhibits the same or similar characteristics as a multi-piece golf ball core. Embodiments of processes 1000 and 100 are discussed in greater detail below.

FIG. 1 is a flowchart showing an embodiment of a process 1000 for forming a golf ball core having multiple core zones. In step 1002, a golf ball is formed, such as core 800 in FIG. 3. Step 1002 may be performed by any known method. For example, in some embodiments, the golf ball core may be molded. The method of forming the golf ball core may be selected based on a variety of factors. For example, the method may be selected based on the type of core material used to make the golf ball core and/or the desired size of the golf ball core.

Step 1004 may include heating the golf ball core, for example golf ball core 860 of FIG. 3, to a first curing temperature to begin curing the golf ball core from the outermost surface toward the center of the golf ball core. The heating process includes any heat exchange process that heats the golf ball core 860 at the indicated rate so as to achieve the desired temperature. In some embodiments, the heating process may use an oven, a hot liquid bath or a hot air source, though any technique known in the art may be suitable.

In some embodiments, step 1002 may be performed together with step 1004 simultaneously. For example, in some embodiments, step 1002 may include compression molding golf ball core 860. Compression molding involves using a mold to heat and press at least one slug of unmolded core material into a golf ball core or a portion of a core. The golf ball core may be compressed in the mold at a pressure ranging from about 600 psi to about 800 psi. For example, the golf ball core may be compressed as a pressure of 695 psi.

The heat applied during compression molding may cause golf ball core 860 to begin to cure from the outermost surface toward the center of the golf ball core. In some embodiments, golf ball core 860 may be heated at a temperature ranging from about 350° F. to about 500° F. For example, golf ball core 860 may be heated at a temperature of about 400° F. Further, golf ball core 860 may be heated at a temperature of about 460° F. In some embodiments, heating step 1004 may last for about one to about four minutes. In other embodiments, heating step 1004 may last for about one to about six minutes. In other embodiments, heating step 1004 may be any length of time less than what would be required to cure the entire core, which is typically around eight minutes depending upon the diameter of the core. For example, golf ball core 860 may be heated for about one and one half minutes. The temperature and duration of heating step 1004 may be selected based upon, for example, the desired thickness of the cured portion of the golf ball core and/or the desired degree of crosslinking.

Step 1006 may include rapidly cooling or quenching golf ball core 860 to stop the curing of the golf ball core. Quenching includes transferring heat from the golf ball core by any suitable method. For purposes of this disclosure, quenching is the removal of heat from the golf ball core at a rate greater than the rate at which an outer core zone of golf ball core is heating an inner core zone. The rate of quenching a golf ball core may depend upon the material used to form the golf ball core, the rate at which the golf ball core was heated, the temperature the golf ball core was exposed to during heating, and the quenching method. Likewise, the temperature of the quenching method and the length of time necessary to quench the golf ball core may depend upon the materials used to form the golf ball core, the rate at which the golf ball core was heated and the temperature the golf ball core was exposed to during heating.

Step 1006 may include any suitable quenching method. For example, in some embodiments, step 1006 may include quenching the golf ball core in a bath of ice and water, a water bath, a cryogenic fluid bath (e.g., liquid nitrogen), dry ice/alcohol bath, or a cooled/cold chamber, though any technique known in the art may be suitable. In some embodiments, the same fluids may be poured over golf ball core 860. In some embodiments, golf ball core 860 is placed in a cooled or cold chamber to quench the golf ball core by convection cooling. The method of quenching the golf ball core may be selected based on a variety of factors. For example, the method of quenching the golf ball core may be selected based on the desired thickness of the cured portion of the golf ball core and/or the desired degree of crosslinking.

By rapidly quenching golf ball core 860, the interior of the golf ball core may be prevented from heating up enough to initiate a crosslinking reaction. As a result, the inner core zone may be left uncured. FIG. 2 illustrates how heating the golf ball core and rapidly quenching a golf ball core partway through a curing process may produce a golf ball core having multiple distinct regions. FIG. 2 shows the golf ball cores with cover layers as finished golf balls.

As shown in FIG. 2, the longer a core is exposed to the curing temperature (step 1004 in FIG. 1) prior to quenching (step 1006 in FIG. 1), the thicker the resultant outer core zone. For example, first core 300 includes a first outer core zone 308 and a first inner core zone 310; second core 302 includes a second outer core zone 312 and a second inner core zone 314; and third core 304 includes a third outer core zone 316 and an inner core zone 318. First core 300 is exposed to the initial cure temperature for a shorter length of time than second core 302 and third core 304. Therefore, first outer core zone 308 is relatively thinner than second outer core zone 312 and third outer core zone 316. Second core 302 is exposed to the initial cure temperature for a longer length of time than first core 300, but a shorter length of time than third core 304. Therefore, first second core zone 312 is relatively thicker than first outer core zone 308 and relatively thinner than third outer core zone 316. Third core 304 is exposed to the initial cure temperature for a longer length of time than first core 300 and second core 302. Therefore, third outer core zone 316 is relatively thicker than first outer core zone 308 and second outer core zone 312.

Golf ball 400 may include a golf ball core 300 and a cover layer 402. Golf ball core 300 may include an outer core zone 308 and an inner core zone 310. Outer core zone 308 may make up a cured region of the core. Inner core zone 310 may make up a cured or uncured region of the core. Golf ball 404 may include a golf ball core 302 and a cover layer 406. Golf ball core 302 may include an outer core zone 312 and an inner core zone 314. Outer core zone 312 may make up a cured region of the core. Inner core zone 314 may make up a cured or uncured region of the core. Golf ball 408 may include a golf ball core 304 and a cover layer 410. Golf ball core 304 may include an outer core zone 316 and an inner core zone 318. Outer core zone 316 may make up a cured region of the core. Inner core zone 318 may make up a cured or uncured region of the core.

In some embodiments, the quenched golf ball core may be dried, for example, with an air knife, and is then brought to ambient temperature before any further processing steps are performed. The golf ball core can be brought to ambient temperature by utilizing a drying oven, or by exposing the golf ball core to air to rise the temperature of the golf ball core to ambient temperature.

Step 1008 may include heating the golf ball core to a second curing temperature to again cure the golf ball core from the outermost surface toward the center of the golf ball core. The temperature the golf ball core is heated to during step 1008 may be high enough to induce crosslinking in the golf ball core. Similar to step 1004, the heating process of step 1008 may use any method known in the art, including but not limited to an oven, a hot liquid bath or a hot air source. The temperature the golf ball core is heated to during step 1008 may be selected based upon the desired hardness of the golf ball core and/or a variety of other factors. The second curing temperature of step 1008 may be different from the first curing temperature of step 1004. The second curing temperature may be lower than the first curing temperature. In some embodiments, the golf ball core may be heated at a temperature ranging from about 280° F. to about 380° F. For example, the golf ball core may be heated at a temperature of about 329° F. In some embodiments, step 1008 may last for about one to about ten minutes. For example, the golf ball core may be heated for about eight minutes. The temperature and duration of the heating process may be selected based upon, for example, the desired thickness of the cured portion of the golf ball core and/or the desired degree of crosslinking.

Step 1010 may include incorporating golf ball core 860 into a finished golf ball by applying at least one cover layer 840 and/or at least one coating. In step 1010, the at least one cover layer 840 may be applied to golf ball core 860 by any suitable method. For example, in some embodiments, the at least one golf ball cover layer 840 may be applied to the golf ball core by injection molding. Applying a golf ball cover layer by injection molding may include placing a golf ball core in a molding containing retractable pins. The material for cover layer 840 is injected into the mold thereby surrounding the golf ball core. At a time specific to the material used to form the cover layer, the retractable pins are removed so as to avoid any defects in the cover layer.

In other embodiments, the at least one golf ball cover layer 840 may be applied to golf ball core 860 with adhesive and pressure. In some embodiments, the at least one golf ball cover layer 840 may be applied to golf ball core 860 through compression molding. In further embodiments, the coating layer may be applied to the at least one cover layer 840 by spraying, rolling, painting, and/or stamping. The method used to apply the at least one cover layer 840 to the golf ball core 860 may be selected based on a variety of factors. For example, the method used to apply the at least one cover layer 840 to golf ball 860 core may be selected based on the type of cover material used and/or the type of method used to form dimples on the outside of the cover layer.

In some embodiments, step 1006 may be performed after step 1010 has already been performed. When step 1006 is performed after step 1010, the entire finished golf ball may be rapidly quenched to also quench the golf ball core.

In some embodiments, step 1010 may be performed before step 1108. In other embodiments, step 1010 may be performed after step 1108. In some embodiments, step 1010 and step 1008 may be performed together simultaneously, as discussed in greater detail below.

When step 1008 is performed after step 1010, the entire finished golf ball 800 may be heated during step 1008. Thus, heating golf ball core 860 may entail heating the entire finished golf ball 800. When step 1008 is performed after step 1010, the finished golf ball 800 may be heated by any suitable method. For example, in some embodiments, heating finished golf ball 800 may be performed by placing the finished golf ball in an oven. In some embodiments, heating finished golf ball 800 may be performed by placing finished golf ball 800 in a heated liquid, such as oil. The temperature of the oven or the heated liquid may be hot enough to induce crosslinking in golf ball core 860. However, the temperature of the over or heated liquid is not so hot that it affects the materials and properties of cover layer 840.

As stated above, some embodiments may include performing step 1010 and step 1008 simultaneously. For example, applying at least one cover layer 840 to golf ball core 860 may be carried out through compression molding. Compression molding involves using a mold to heat and press the cover layer onto the golf ball core. While heating the cover layer to the golf ball core, the golf ball core may absorb the heat applied to the cover layer. As a result, the golf ball core may cure from the outermost surface toward the center of the golf ball core for the duration of time that the mold continues to apply heat to the golf ball core.

In some embodiments, golf ball core 860 is again rapidly quenched after step 1008 to halt the curing of the golf ball core. When quenching is performed after step 1010 has already been performed, the entire finished golf ball may be quenched. Quenching the golf ball core may include any suitable quenching method. For example, in some embodiments, quenching golf ball core 860 may include quenching golf ball core 860 in a bath of ice and water, a water bath, a cryogenic fluid bath (e.g., liquid nitrogen), dry ice/alcohol bath, or cold/cooled chamber. In some embodiments, the same fluids may be poured over the finished golf ball 800. The method of quenching golf ball core 860 may be selected based on a variety of factors. For example, the method of quenching golf ball core 860 may be selected based on the desired thickness of the cured portion of the golf ball core and/or the desired degree of crosslinking.

While the golf ball cores in the embodiment in FIG. 2 are shown with two distinct core zones, the golf ball cores may include more than two distinct core zones. Steps 1004 and 1006 may be repeated two or more times to form two or more core zones. The number of distinct core zones may be selected based on a variety of factors. For example, the number of distinct core zones may be selected based on the desired coefficient of restitution.

Similar to golf ball cores 300, 302 and 304 of FIG. 2, the thickness of the outer core zone 830, middle core zone 860 and inner core zone 810 of golf ball core 860 of golf ball 800 shown in FIG. 3 may vary with the amount of time the golf ball core 860 is exposed to heat in each curing step. For example, middle core zone 820 may be thicker if exposed to heat for a longer period of time, or may be thinner if exposed to a short period of time. The thickness of each distinct core zone may be selected based on a variety of factors. For example, the thickness of each core zone may be selected based on the desired coefficient of restitution.

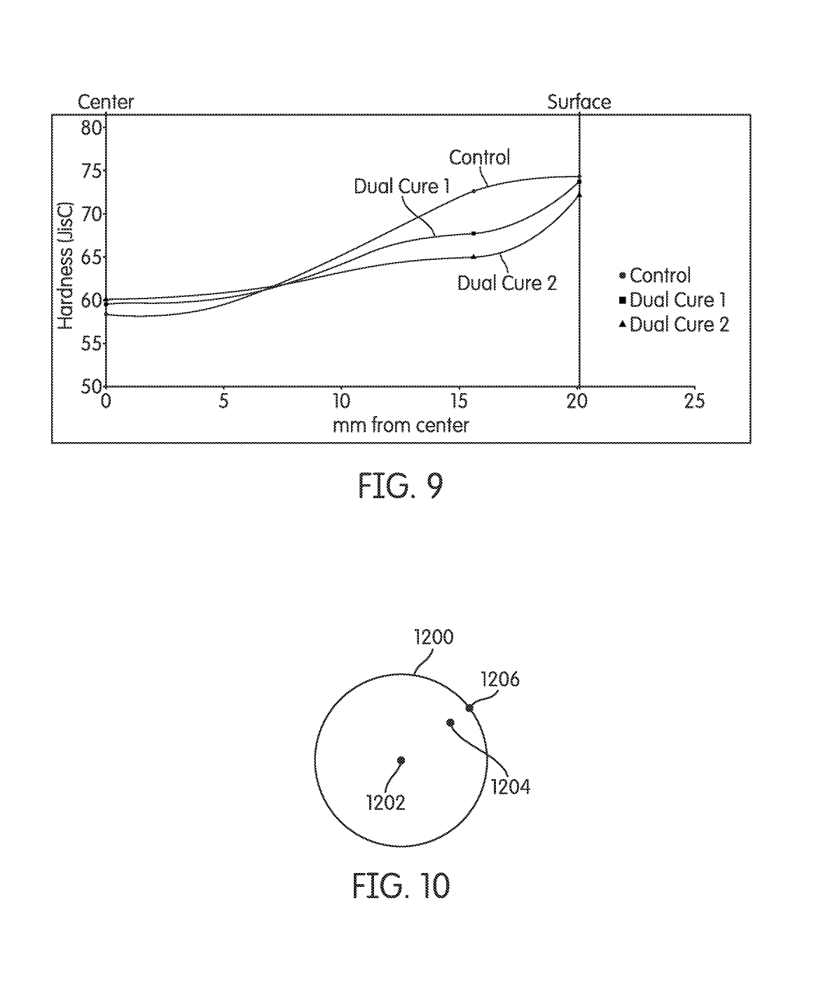

As an example, a golf ball core is formed by compression molding a rubber material. The golf ball core is exposed to a first curing temperature of 400° F. for 1.5 minutes. Exposure to the first curing temperature can take place during compression or after compression. The golf ball core is then quenched in a liquid nitrogen bath to halt the curing process. Following quenching, golf ball core may be dried, for example, with an air knife, and is then brought to ambient temperature by any suitable method, including but not limited to, a drying oven or exposure to air to rise the temperature of the golf ball core to ambient temperature. The golf ball core is then exposed to a second curing temperature of 329° F. for 8 minutes to complete the curing of the golf ball core to a desired level. A cover layer is formed around the twice cured golf ball core. For purposes of FIG. 9, discussed below, this example will be referred to as Dual Cure 1.

In another example, a golf ball core is formed by compression molding a rubber material. The golf ball core is exposed to a first curing temperature of 460° F. for 1.5 minutes. Exposure to the first curing temperature can take place during compression or after compression. The golf ball core is then quenched in a liquid nitrogen bath to halt the curing process. Following quenching, golf ball core may be dried, for example, with an air knife, and is then brought to ambient temperature by any suitable method, including but not limited to, a drying oven or by exposing the golf ball core to air to rise the temperature of the golf ball core to ambient temperature. The golf ball core is then exposed to a second curing temperature of 329° F. for 8 minutes to complete the curing of the golf ball core to a desired level. A cover layer is formed around the twice cured golf ball core. For purposes of FIG. 9, discussed below, this example will be referred to as Dual Cure 2.

FIG. 9 is a graph that illustrates the hardness gradient for a standard golf ball core (Control) and the hardness gradient for two golf ball cores formed by the embodiments of process 1000. The Control shown on the graph is a standard golf ball core formed by heating the compressed core material for about eight minutes at a temperature of about 329° F. Dual Cure 1 and Dual Cure 2 are formed by the examples discussed directly above. FIG. 10 shows the points at which the hardness of each golf ball core 1200 (for each of Control, Dual Cure 1, and Dual Cure 2) was measured. The hardness of each core was measured at center point 1202, middle point 1204 which is 15.6 mm from the center of the golf ball core, and outer point 1206, which is at the surface of the golf ball core or 20.1 mm from the center of the golf ball core. The hardness values (in JIS-C) for the Control, Dual Cure 1 core, and Dual Cure 2 core are set for the below in Table 1.

TABLE 1
Hardness Measurements for Golf Ball Cores

| Distance From | | | |
|---|---|---|---|
| Center of Core (in | | | |
| mm) | Control | Dual Cure 1 | Dual Cure 2 |
| 0 | 58.4 | 59.6 | 60.2 |
| 15.6 | 72.7 | 67.7 | 64.8 |
| 20.1 | 74.1 | 73.8 | 72.2 |

As illustrated in FIG. 9, the hardness gradient for the Control (standard golf ball core) exhibits a sigmoidal curve with the hardness plateauing at or near the surface of the golf ball core. However, the hardness gradient for the golf ball cores formed by the present disclosure, Dual Cure 1 and Dual Cure 2, exhibited a different curve than that of the Control. The curve depicting the hardness gradient of Dual Cure 1 and Dual Cure 2 exhibits an increase in hardness at or near the surface of the golf ball core rather than a continuing to plateau, which deviates from the more standard sigmoidal curve of the Control. The hardness values displayed in Table 1 and the curves of FIG. 9 show the different hardness gradients for the golf ball cores formed by the process of the disclosure (Dual Cure 1 and Dual Cure 2) when compared to the conventional method of making a golf ball core (Control).

The Control core, Dual Cure 1 and Dual Cure 2 core have similar hardness values at the center and at the surface of each core. However, the hardness values of Dual Cure 1 and Dual Cure 2 are noticeably lower at a point 15.6 mm from the center of each core than the hardness value for the Control at a point 15.6 mm from the center of the core. By performing at least two curing steps when forming the golf ball cores of Dual Cure 1 and Dual Cure 2, a one-piece golf ball core having the characteristics of a multilayer core is formed.

A golf ball containing the golf ball core formed by the embodiments of process 1000 has one piece solid core that has the characteristics and advantages of a multi-piece core. The golf ball core formed by process 1000 minimizes many material discontinuity effects between the core zones, such as the possibility of delamination or poor adhesion, because the golf ball core is a homogenous, one piece core, unlike a multi-piece golf ball core. Multi-piece golf ball cores may have incompatible materials forming the multiple layers resulting in poor adhesion between the layers and, in turn, a loss of performance. A golf ball containing the golf ball core formed by the embodiments of process 1000 provide better feel for the golfer throughout the bag. In addition, golf balls containing the golf ball cores formed by process 1000 exhibit improved spin for better control of the golf ball without loss of driver or long iron distance. Further, the golf ball designer, by varying the curing temperatures and curing times, can have a high degree of control over the resultant properties of the finished golf ball. Still further, the disclosure provides a process that forms a two-piece golf ball that exhibits characteristics of a three-piece or four-piece golf ball without the costs associated with forming the multiple layers.

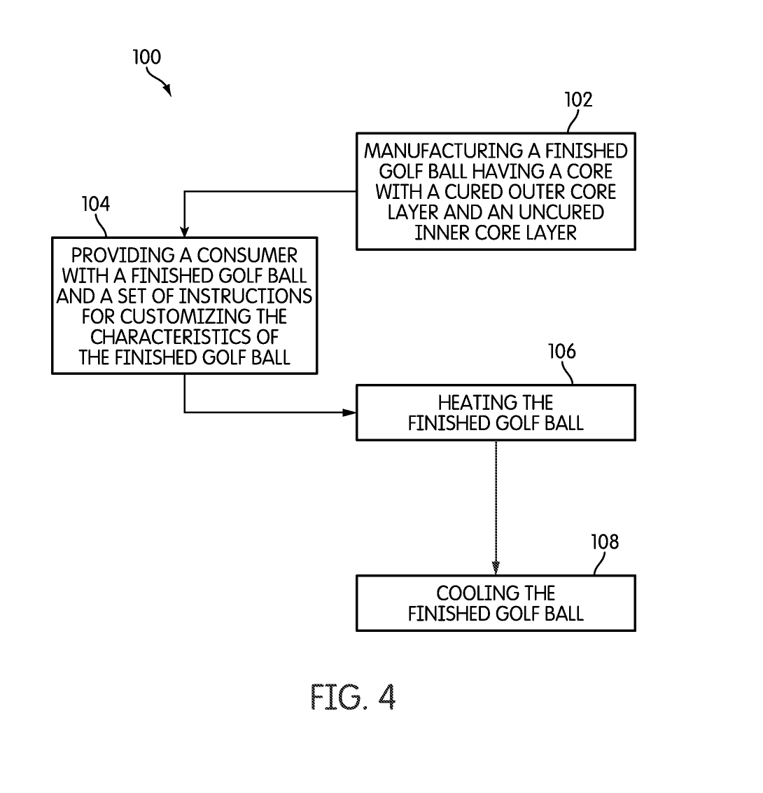

The disclosure further provides a method of customizing a golf ball having at least a portion of the golf ball core that is uncured. FIG. 4 is a flowchart showing the overall process 100 by which a golf ball may be customized. Step 102 may include manufacturing a finished golf ball having a core with a cured outer core zone and an uncured inner core zone. A finished golf ball is a golf ball that includes all layers and components necessary for the golf ball to be used by a golfer in a game of golf. The finished golf ball may be a two-piece ball, having a core and a cover layer. The finished golf ball may include any number of layers, so long as the golf ball includes at least a core having at least two core zones and at least one cover layer substantially disposed around the core. The technique of the disclosure may be applied to any layer of a golf ball that is formed having a rubber composition. For example, the cure, quench, cure technique could be applied to a mantle that is formed having a rubber composition.

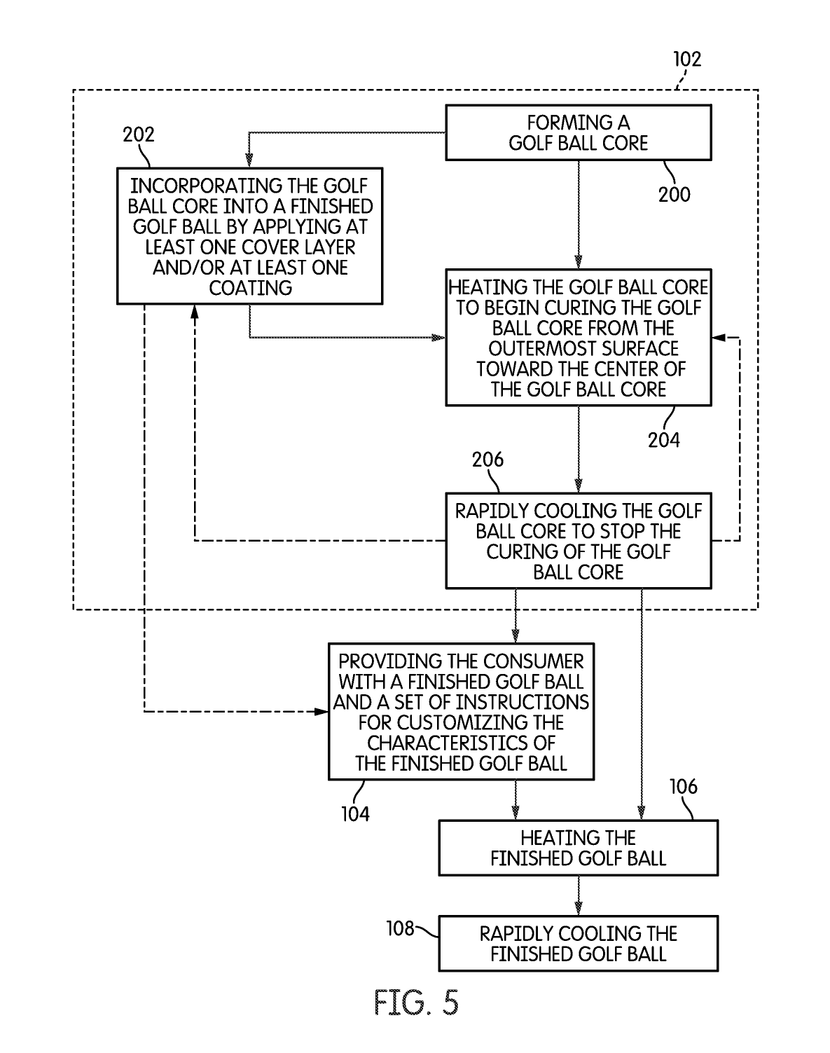

FIG. 2 shows a finished golf ball 400 having a golf ball core 300 with a cured outer core zone and an uncured inner core zone. Finished golf ball 400 may include a golf ball core 300 with an outer core zone 308 and an inner core zone 310. Inner core zone 310 may be uncured and outer core zone 308 may be cured. Step 102 is described in more detail below with reference to FIG. 5.

The core material used to make the golf ball cores may include any suitable type of core material that may be cured (vulcanized). For example, in some embodiments, the golf ball cores may be formed primarily of rubber, such as a diene-containing composition, or metallocene catalyzed polyolefin. The type of core material used to make the golf ball cores may be selected based upon a variety of factors. For example, the golf ball core material may be selected based upon the desired coefficient of restitution.

Step 104 may include providing a consumer with a finished golf ball and a set of instructions for customizing the characteristics of the finished golf ball. In some embodiments, step 104 may be performed before step 106. In other embodiments, step 104 may be omitted and step 102 may be performed directly before step 106. Generally, step 106 and step 108 may be performed by a party other than the party responsible for manufacturing the golf ball. The golf ball may thereby undergo aftermarket customization. The customization may be performed by anyone post-manufacture, such as the end-user him or herself, or by (for example) a golf pro at a golf pro shop.

Step 106 may include heating the finished golf ball to a preselected temperature. The preselected temperature may be any temperature that delivers sufficient heat energy to cause crosslinking within the uncured inner core zone. The exact value of this temperature may depend on the type of material used in the golf ball core. The heating may cure the uncured inner core zone causing the inner core zone to increase in hardness. The desired hardness of the golf ball core may be selected by the end-user consumer golfer, or by another person such as a golf pro, so that the golf ball will achieve desired play characteristics. For example, if the golfer intends to play in colder weather, the golfer may select a lower hardness as the desired hardness. In some embodiments, the preselected temperature may be built into the steps of a heating process. In other words, instead of aiming to achieve a certain preselected temperature, an end-user consumer golfer may follow certain heating steps that may lead to a preselected temperature. For example, an end-user consumer golfer may microwave a finished golf ball on high power for 1 minute. While this process may raise the temperature of the finished golf ball to a preselected temperature, the end-user consumer golfer may not be aware of the preselected temperature. The specific microwaving process may achieve the preselected temperature. Thus, step 106 may include a process that heats the golf ball to a preselected temperature without a user knowing the preselected temperature.

Step 108 may include cooling or quenching the finished golf ball to halt the curing process. The golf ball may be quenched at a preselected rate that corresponds to the selected desired hardness. The preselected rate in cooling may control the degree of crosslinking occurring in the inner core zone. The core material may have a low thermal conductivity causing the golf ball core to hold heat long enough to fully cure any uncured regions of the golf ball core. The faster the golf ball core is quenched, the sooner the crosslinking is halted. Thus, the rate at which the cured core zone quenches may control the degree of crosslinking.

FIG. 5 is a flowchart showing step 102 in greater detail. Step 200 may include forming a golf ball core. Step 200 may be performed by any known method. For example, in some embodiments, the golf ball core may be molded. The method of forming the golf ball core may be selected based on a variety of factors. For example, the method may be selected based on the type of core material used to make the golf ball core and/or the desired size of the golf ball core.

Step 204 may include heating the golf ball core to begin curing the golf ball core from the outermost surface toward the center of the golf ball core. In some embodiments, step 200 may be performed together with step 204 simultaneously. For example, in some embodiments, step 200 may include compression molding a golf ball core. Compression molding involves using a mold to heat and press at least one slug of unmolded core material into a golf ball core. The heat applied during compression molding may cause the golf ball core to begin to cure from the outermost surface toward the center of the golf ball core. In some embodiments, the golf ball core may be compression molded at a temperature ranging from 300° F. to 500° F. For example, the golf ball core may be compression molded at a temperature of 400° F. In some embodiments, the golf ball core may be compression molded at a temperature of 460° F. In some embodiments, the compression molding may last for one to four minutes. The temperature and duration of the compression molding process may be selected based upon, for example, the desired thickness of the cured portion of the golf ball core and/or the desired degree of crosslinking.

Step 202 may include incorporating the golf ball core into a finished golf ball by applying at least one cover layer and/or at least one coating. In step 202, the at least one cover layer may be applied to the golf ball core by any suitable method. For example, in some embodiments, the at least one golf ball cover layer may be applied to the golf ball core with adhesive and pressure. In some embodiments, as discussed below with respect to performing step 202 and step 204 simultaneously, the at least one golf ball cover layer may be applied to the golf ball core through compression molding. The method used to apply the at least one cover layer to the golf ball core may be selected based on a variety of factors. For example, the method used to apply the at least one cover layer to the golf ball core may be selected based on the type of cover material used and/or the type of method used to form dimples on the outside of the cover layer.

In step 202, the coating may be optionally applied to the golf ball core by any suitable method. For example, in some embodiments, the coating may be applied to the at least one cover layer by spraying. The method used to apply the coating to the at least one cover layer may be selected based on a variety of factors. For example, the method used to apply the coating to the at least one cover layer may be selected based on the type of coating material used and/or the type of cover material used.

In some embodiments, step 202 may be performed before step 204. In other embodiments, step 200 may be performed directly before step 204 is performed. In such embodiments, step 202 may be performed after step 204 and step 206. In some embodiments, step 202 and step 204 may be performed together simultaneously, as discussed in greater detail below.

When step 204 is performed after step 202, the entire finished golf ball may be heated during step 204. Thus, heating the golf ball core may entail heating the entire finished golf ball. When step 204 is performed after either step 200 or step 202, the golf ball core may be heated by any suitable method. For example, in some embodiments, heating the golf ball core may be performed by placing the golf ball core in an oven. In some embodiments, heating the golf ball core may be performed by placing the golf ball core in a heated liquid, such as oil. The temperature of the oven or the heated liquid may be hot enough to induce crosslinking in the golf ball core.

The temperature the golf ball core is heated to during step 204 may be high enough to induce crosslinking in the golf ball core. The temperature the golf ball core is heated to during step 204 may be selected based upon the desired hardness of the golf ball core and/or other factors. The method used to heat the golf ball core may be selected based on a variety of factors. For example, in some embodiments, the method used to heat the golf ball core may be selected based on whether or not the golf ball core is heated before, during or after the golf ball core has been incorporated into a finished golf. In some embodiments, the method used to heat the golf ball core may be selected based on equipment available to the person heating the golf ball core.

As stated above, some embodiments may include performing step 202 and step 204 simultaneously. For example, applying at least one cover layer to the golf ball core may be carried out through compression molding. Compression molding involves using a mold to heat and press the cover layer onto the golf ball core. While heating the cover layer to the golf ball core, the golf ball core may absorb the heat applied to the cover layer. As a result, the golf ball core may begin to cure from the outermost surface toward the center of the golf ball core.

Step 206 may include rapidly quenching the golf ball core to stop the curing of the golf ball core. When step 206 is performed after step 202 has already been performed, the entire finished golf ball may be rapidly quenched to quench the golf ball core. Step 206 may include any suitable quenching method. For example, in some embodiments, step 206 may include quenching the golf ball core in a bath of ice and water, a water bath, a cryogenic fluid bath (e.g., liquid nitrogen), dry ice/alcohol bath, or cold/cooled chamber. In some embodiments, the same fluids may be poured over the finished golf ball. The method of quenching the golf ball core may be selected based on a variety of factors. For example, the method of quenching the golf ball core may be selected based on the desired thickness of the cured portion of the golf ball core and/or the desired degree of crosslinking.

By rapidly quenching the golf ball core, the interior of the golf ball core may be prevented from heating up enough to initiate a crosslinking reaction. As a result, the inner core zone may be left uncured. FIG. 2 illustrates how heating the golf ball core and rapidly quenching a golf ball core partway through a curing process may produce a golf ball core having multiple distinct regions. FIG. 2 shows the golf ball cores in finished golf balls with cover layers. Golf ball 400 may include a golf ball core 300 and a cover layer 402. Golf ball core 300 may include an outer core zone 308 and an inner core zone 310. Golf ball 404 may include a golf ball core 302 and a cover layer 406. Golf ball core 302 may include an outer core zone 312 and an inner core zone 314. Golf ball 408 may include a golf ball core 304 and a cover layer 410. Golf ball core 304 may include an outer core zone 316 and an inner core zone 318. The outer core zone of each golf ball core may make up a cured region of the core. The inner core zone of each golf ball core may make up an uncured region of the core.

While the golf ball cores in the embodiment in FIG. 2 are shown with two distinct core zones, the golf ball cores may include more than two distinct core zones. To achieve more than two distinct core zones, step 204 and 206 may be repeated to form the desired number of core zones. The number of distinct core zones may be selected based on a variety of factors. For example, the number of distinct core zones may be selected based on the desired coefficient of restitution.

As indicated by the cure time line 306 in FIG. 2, the cured region of the golf ball core may increase as the golf ball core is exposed to heat. For example, golf ball core 302 may be exposed to heat longer than golf ball core 300. Thus, outer core zone 312 may be thicker than outer cure layer 308. Similarly, golf ball core 304 may be exposed to heat longer than golf ball core 302. As a result, outer core zone 316 may be thicker than outer core zone 312. In some embodiments, a golf ball core may have different thicknesses for each core zone as fully described in U.S. patent application Ser. No. 13/341,374, entitled Method of Making a Golf Ball Core, and filed on Dec. 30, 2011, the disclosure of which is hereby incorporated in its entirety.

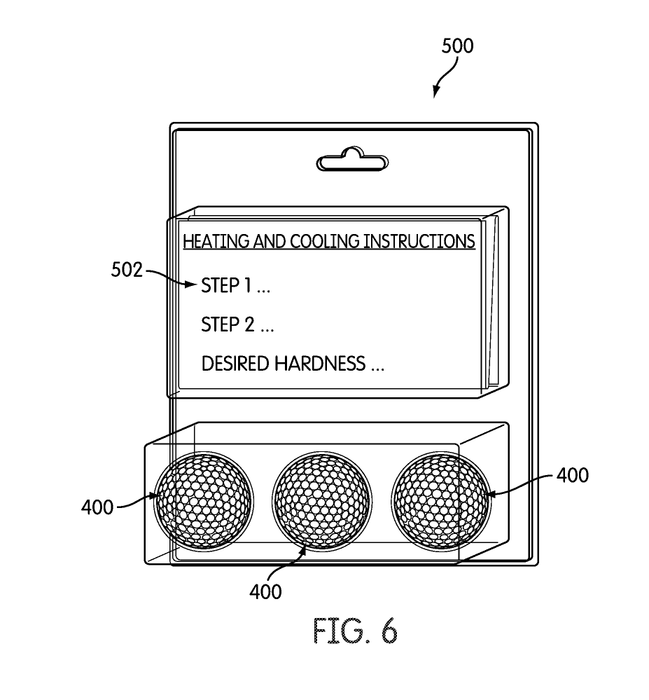

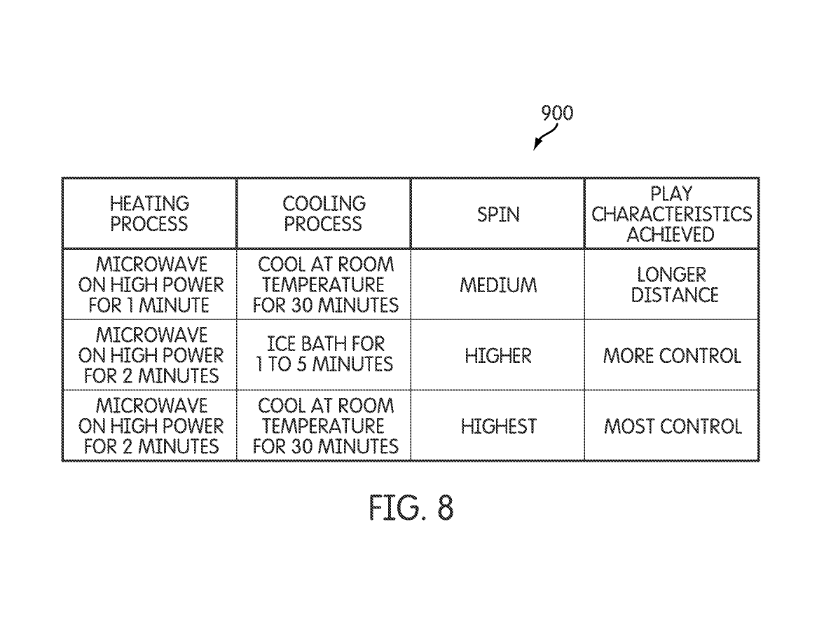

FIG. 6 shows an example of a kit 500 that may be used to carry out the method of the disclosure. Kit 500 may include at least one golf ball 400, discussed above, and a set of instructions 502 for customizing the characteristics of the golf ball. In some embodiments, instructions 502 may include a graphical representation indicating to the end-user consumer to heat the golf ball to a preselected temperature, and then quench the golf ball at a preselected rate so as to cause the golf ball to exhibit a desired play characteristic. In some embodiments, instructions 502 may include a chart displaying which methods produce certain play characteristics. For example, FIG. 8 shows a chart 900 displaying methods of performing step 106 and step 108 to achieve longer distance, more control, or most control. These heating processes and quenching processes are exemplary. In some embodiments, the heating process may include other types of heating, such as heating in an oven or a hot liquid bath. In some embodiments, the heating process may include heating the golf ball at a certain temperature. For example, in some embodiments, the golf ball may be heated in an oven preheated to 400° F. In some embodiments, the golf ball may be heated in an oven preheated to 460° F. In some embodiments, the heating process may include heating the golf ball for other lengths of time. For example, the golf ball may be heating in an oven for 20 minutes.

In some embodiments, chart 900 may include other types of quenching processes, such as quenching in a refrigerator, freezer, and/or a water bath. Similar to the heating processes, the quenching processes may include different times or temperatures. For example, a water bath may be cooled to a preselected temperature before the golf ball is quenched in the water bath.

The play characteristics listed in chart 900 are exemplary. In some embodiments, other play characteristics and/or ball characteristics may be listed in chart 900 instead of or in addition to the play characteristics shown in FIG. 8. For example, chart 900 may list ball hardness and/or ball feel.

In some embodiments, a kit may include an additive that aids in the heating and/or quenching steps. The additive may be any substance that can be added to a heat exchange medium (such as warm or cold water) or to the golf ball itself, in order to improve an aspect of the heating or quenching step. The additive may be (for example) a water softener to remove salts from water that would otherwise negatively affect the golf ball by forming deposits thereon. The additive may also be, for example, an external microwave absorbing additive that is placed on the outside of the golf ball cover layer in order to aid in the absorption of microwaves when step 106 includes using a microwave. More generally, the additive may be (for example) a purified high specific heat liquid, such that a consumer may heat or quench the golf ball using the purified high specific heat liquid instead of water.

In some embodiments, a kit used to carry out the method of the disclosure may include a heater. For example, the kit may include the handheld clamp fully described in U.S. Patent Publication Number 2011/0095012, entitled Device for Heating a Golf Ball, and filed on Oct. 23, 2009, the disclosure of which is hereby incorporated in its entirety. In some embodiments, the kit may include a stand and a handheld clamp for holding the finished golf ball during customization as fully described in U.S. Patent Publication Number 2011/0177890, entitled Methods and Systems for Customizing a Golf Ball, and filed on Jan. 20, 2010, the disclosure of which is hereby incorporated in its entirety.

Accordingly, the present method and systems of kits allows aftermarket customization of a golf ball. An end-user, or other person, may perform the method on a golf ball so as to achieve a desired play characteristic, and thereby avoid the need to purchase multiple sets of golf balls having different inherent immutable play characteristics. From the perspective of a manufacturer, the method of providing a golf ball and indicating to the user allows the manufacturer to provide a superior system for customizing golf balls to their customers.

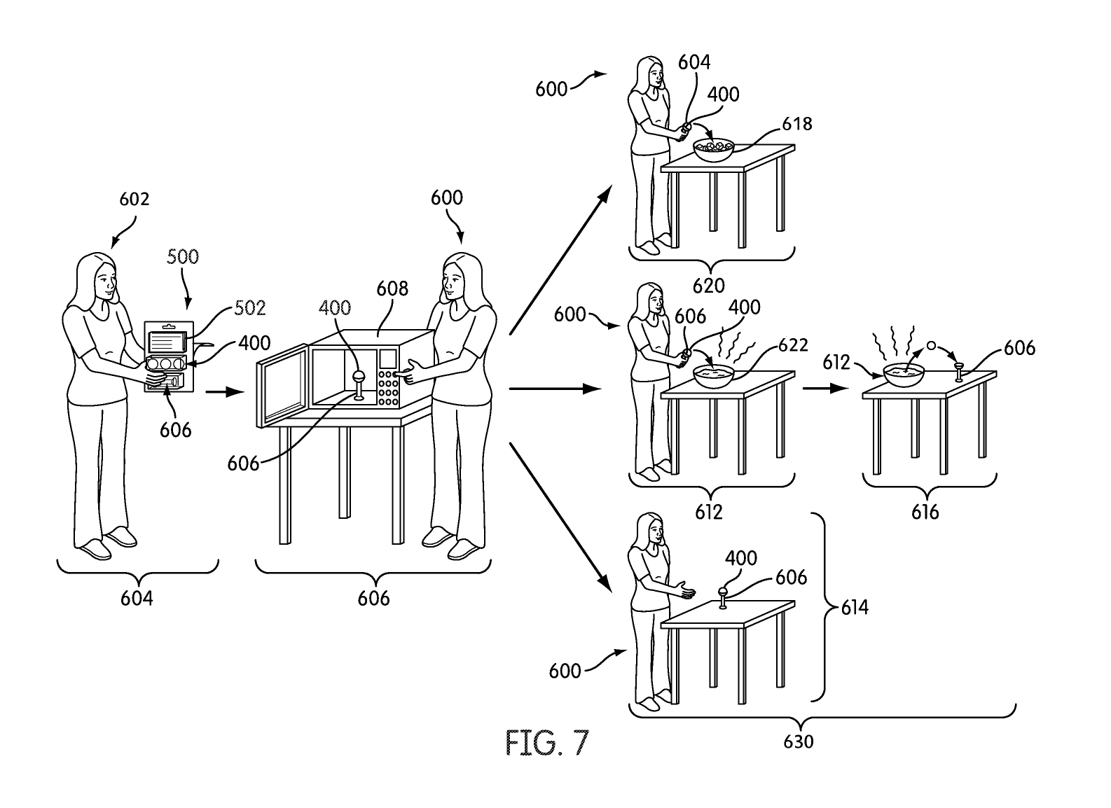

FIG. 7 shows an end-user performing an embodiment of the method shown in FIGS. 1 and 2. Specifically, the end user 600 may receive a kit 602 in step 604. Kit 602 may be similar to kit 500 discussed above, and may include at least one golf ball 400, a set of instructions 502, and a stand 606 for holding golf ball 400. Instructions 502 may include the chart shown in FIG. 8. End-user 600 may consult instructions 502 when customizing the golf ball.

Next, in step 606, end-user 600 may heat golf ball 400 to a preselected temperature using a microwave 608 by placing golf ball 400 on stand 606 inside microwave 608. The end-user may choose a desired hardness and/or play characteristics and select the heating power and heating time. For example, in some embodiments, the end-user may choose from low, medium, and high microwave power settings. The end-user may also choose from among the following heating times: one minute, two minutes, three minutes, four minutes, five minutes, and six minutes. For example, an end-user may prefer a softer ball and may, therefore, choose to heat golf ball 400 for one minute on a medium power setting. In another example, the end-user may prefer a harder ball and may, therefore choose to heat golf ball 400 for three minutes on a high power setting.

In some embodiments, cover layer 402 of golf ball 400 may include a microwave transparent material. Generally, a microwave transparent material allows microwaves pass through the material. Using a microwave transparent material in cover layer 402 may ensure that the cover layer allows heat to pass through to the golf ball core.

After step 606, the end-user may choose a desired hardness and select one of three quenching paths in step 630. For example, if end user 600 desires a soft inner core zone, then the end-user may perform step 620 by quenching golf ball 400 in a cold water bath 618. In a particular embodiment, the cold water bath may have a temperature of between about 4° F. and about 13° F., and golf ball 400 may be quenched for a time period of from about one minute to about five minutes. However, a variety of alternative methods of quickly quenching the golf ball are within the scope of step 620, as are known in the art of heat exchangers. For example, step 620 may include quenching the golf ball core in a bath of ice and water, a water bath, a cryogenic fluid bath (e.g., liquid nitrogen), dry ice/alcohol bath, or cold/cooled chamber. In some embodiments, step 620 may include pouring fluids over the finished golf ball.

Alternatively, if end-user 600 desires a harder inner core zone on golf ball 400, in some embodiments, end-user 600 may perform steps 612 and 616 or step 614. In step 612, end-user 600 may cool golf ball 400 in a warm water bath 622. The warm water bath 622 may have a temperature of between about 40° F. and about 70° F. Golf ball 400 may be placed in warm water bath 622 for a time period of from about one minute to about ten minutes. Subsequently, after step 612, golf ball 400 may be removed from warm water bath 612 and placed on stand 606 to air cool to room temperature. Golf ball 400 may be allowed to slowly air cool, without an intermediate quenching step, as in step 614.

In some embodiments, end-user 600 may perform step 614 to quench golf ball 400. In step 614, end-user 600 removes golf ball 400 on stand 606 from microwave 608. Golf ball 400 on stand 606 is placed on a surface and exposed to the air to cool the golf ball core at ambient temperature.

Generally, FIG. 7 shows an embodiment of how an end-user may perform the step 106 and step 108 using readily available household equipment. However, each of steps 606, 620, 612, 614, and 616, and are intended to broadly encompass any heat exchange process that heats or quenches the golf ball at the indicated rate so as to achieve the desired hardness. For example, the heating process may use a conventional oven, a hot liquid bath, or a hot air source. The use of readily available household equipment makes the process easy for an end-user consumer to perform. However, larger scale heat exchange systems may be used in other embodiments, such as when the method is performed in a golf pro-shop.

FIG. 2 illustrates golf ball 402, golf ball 404, and golf ball 408 after step 106 and step 108. Inner core 310, inner core 314, and inner core 316 may be cured after step 106 and step 108.

FIG. 3 illustrates an embodiment in which a golf ball 800 has a cover layer 840 and a core 860 including three distinct core zones. An outer core zone 830 may be developed during a first curing process. For example, step 204 and step 206 may be performed to develop outer core zone 830. A middle core zone 820 may be developed during a second curing process. For example, step 106 and step 108 may be performed a second time to develop middle core zone 820. And an inner core zone 810 may be developed during a third curing process. For example, step 106 and step 108 may be repeated to develop middle core zone 820. Further, step 106 and step 108 may be repeated one or more times to develop multiple core zones in the golf ball core. The number of times step 106 and step 108 are repeated may be selected based upon, for example, the desired number of core zones, the desired level of cure achieved, and/or the desired degree of crosslinking.

The cure, quench, cure method described above may be used with balls that do not have a rubber layer as the center of the golf ball. For example, a golf ball may have a core made of another material surrounded by a rubber layer. Examples of such ball structures may be found in U.S. Patent Application Publication Number 2011/0053707 (resin core layer and rubber intermediate layer), U.S. Patent Application Publication Number 2011/0053707 (resin inner core layer and rubber outer core layer), U.S. Patent Application Publication Number 2012/0214615 (resin inner core layer and rubber outer core layer), and U.S. Patent Application Publication Number 2012/0077621 (resin inner core layer and rubber outer core layer), all of which are incorporated herein by reference thereto. The cure, quench, cure method described herein could be readily applied to these types of structures by one of ordinary skill in the art once the rubber layer has been applied to the underlying layers, such as by compression molding the rubber onto a resin sphere. The cure, quench, cure method described herein would form distinct zones in the rubber layer, where each zone has a different hardness and/or hardness gradient.

Any portion of any embodiment can be used with any embodiment described in this disclosure. A variety of combinations and variations of any embodiment are encompassed by this disclosure.

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. Also, various modifications and changes may be made within the scope of the attached claims.

What is claimed is:

1. A method of making a golf ball core, comprising:
forming a golf ball core;
heating the golf ball core to cure a first portion of the golf ball core;
quenching the golf ball core before the golf ball core finishes curing throughout the entire golf ball core, wherein an uncured portion of the golf ball core remains uncured; and
heating the golf ball core a second time to cure at least a second portion of the golf ball core.

2. The method according to claim 1, wherein heating the golf ball core to cure the first portion of the golf ball core includes heating the golf ball core to a first temperature for a first length of time.

3. The method according to claim 2, wherein the first temperature ranges from about 350° F. to about 500° F.

4. The method according to claim 2, wherein the first length of time ranges from about one to less than eight minutes.

5. The method according to claim 1, wherein heating the golf ball core to cure the second portion of the golf ball core includes heating the golf ball core to a second temperature for a second length of time.

6. The method according to claim 5, wherein the second temperature ranges from about 280° F. to about 380° F.

7. The method according to claim 5, wherein the second length of time ranges from one to ten minutes.

8. A method of forming a golf ball, comprising:
a) forming a golf ball core by compression molding a slug of core material into a golf ball core;
b) heating the golf ball core to cure at least a first portion of the golf ball core;
c) quenching the golf ball core before the golf ball core finishes curing throughout the entire golf ball core, wherein a second portion of the golf ball core remains uncured;
d) allowing the golf ball core temperature to reach ambient temperature;
e) heating the golf ball core a second time to cure at least a second portion of the golf ball core; and
f) incorporating the golf ball core into a finished golf ball by applying at least one cover layer.

9. The method according to claim 8, wherein heating the golf ball core to cure the first portion of the golf ball core includes heating the golf ball core to a first temperature for a first length of time.

10. The method according to claim 9, wherein the first temperature is about 400° F.

11. The method according to claim 9, wherein the first temperature is about 460° F.

12. The method according to claim 9, wherein the first length of time is about one and one half minutes.

13. The method according to claim 8, wherein heating the golf ball core to cure the second portion of the golf ball core includes heating the golf ball core to a second temperature for a second length of time.

14. The method according to claim 13, wherein the second temperature is about 329° F.

15. The method according to claim 13, wherein the second length of time is about eight minutes.

16. The method according to claim 8, wherein the golf ball core reaches ambient temperature by utilizing a drying oven.

17. A golf ball, comprising:
a core having a uniform rubber recipe throughout the entirety of the core;
the core having a first core zone and a second core zone,
wherein the first core zone substantially surrounds the second core zone,
wherein the first core zone exhibits characteristics of the uniform rubber recipe when the uniform rubber composition is cured at a first temperature for a first length of time, and
wherein the second core zone exhibits characteristics of the uniform rubber recipe when the uniform rubber recipe is cured at a second temperature for a second length of time.

18. The golf ball according to claim 17, wherein the first temperature is greater than the second temperature.

19. The golf ball according to claim 17, wherein first length of time is less than the second length of time.

20. The golf ball according to claim 17, wherein the characteristics exhibited by the first core zone and second core zone are hardness gradients;
wherein the hardness gradient of the first core zone is distinct from the hardness gradient of the second core zone.

21. The golf ball according to claim 20, wherein the hardness gradient of the first core zone is greater than the hardness gradient of the second core zone.
